(19) United States
(12) Patent Application Publication
(10) Pub. No.: US 2007/0160413 A1
(43) Pub. Date: Jul. 12, 2007

(54) Pen

(76) Inventor: Teodoro Acusar Ybanez JR., Cebu (PH)

Correspondence Address: Teodoro A. Ybanez, Jr.;Camputhaw, 317 Tojong St., Cebu City, 6000, PH

(21) Appl. No.: 11/715,788

(22) Filed: Mar. 9, 2007

(30) Foreign Application Priority Data
Mar. 18, 2005 (PH) PCT/PH05/00008

(51) Int. Cl. B43K 29/00

(52) U.S. Cl. 401/195

(57) ABSTRACT

The present invention relates in general to a writing instrument but more particularly to a handy and portable pen being provided with a piece of writing paper which can be tear off or retracted which is disposed along the pen assembly making it handy, compact and useful in any situation.

### FIELD OF INVENTION

The present invention relates to a writing instrument but more particularly to an improved pen having a detachable and refillable paper within the pen assembly with a pull-out/retract feature for convenient and practical uses thereof.

At present, a lot and different kinds of writing implements and writing tools abound the market. Manufacturers have also devised different implements such as clips, hooks, and the like just to be able to make the pen practical, compact and useful.

However, they forgot to incorporate the handiness of incorporating a writing pad that makes the writing instruments more useful especially in times of urgency.

There are also pens that are provided with piece of paper but are of limited length and pulling it or tearing it poses a problem since the whole piece of paper is taken out making the idea inutile and useless.

Also, said pens with piece of paper are quite heavy since they use a lot of parts that controls the movement of the paper within the pen aside from being cumbersome when replacing the ink tube because of the many parts involved in the assembly.

Furthermore said pens are not convenient to use as they involve numerous moving parts. Also, said other pens only dispense paper and cannot retract the used paper back inside the pen for convenient and safe storage.

### SUMMARY OF THE INVENTION

It is therefore the main object of the present invention for an improved pen to pro vide a solution to the glaring drawbacks apparent and inherent to prior arts by providing an improved pen with retractable/tearable piece of paper disposed within its assembly.

Another object of the present invention is to provide an improved pen that is handy, elegant and practical to use.

Still an object is to provide an improved pen that is effective, sturdy, affordable and with an easy to replace ink tube since the assembly for the dispensing of paper is different and apart from the writing pen assembly.

Yet another object of the present invention is to provide an improved pen with piece of paper disposed within its assembly having an attaching means provided on its back portion for attaching said paper to any desirable surface thereof.

Other objects and advantages of the present invention will be highly appreciated and be easily understood upon reading the detailed description taken in conjunction with the appended drawings.

### DESCRIPTION OF THE DRAWINGS

FIG. 1 is a perspective view of the improved pen with its cap in placed.

FIG. 2 is another perspective view of the improved pen with detached cap and the piece of paper in retracted position.

FIG. 3 is an exploded perspective view of the same shown with a slide out piece of paper.

FIG. 4 is a perspective view of the second embodiment for an improved pen.

FIG. 5 is an exploded perspective view of FIG. 4.

FIG. 6 is an exploded perspective view of another embodiment of the present invention.

FIG. 7 is an enlarged cross-sectional view of FIG. 6; and

FIG. 8a is a front view of another embodiment of the present invention showing the piece of paper being used.

FIG. 8b is a back view of another embodiment of the present invention showing the piece of paper being used.

### DETAILED DESCRIPTION OF THE PREFERRED EMBODIMENTS

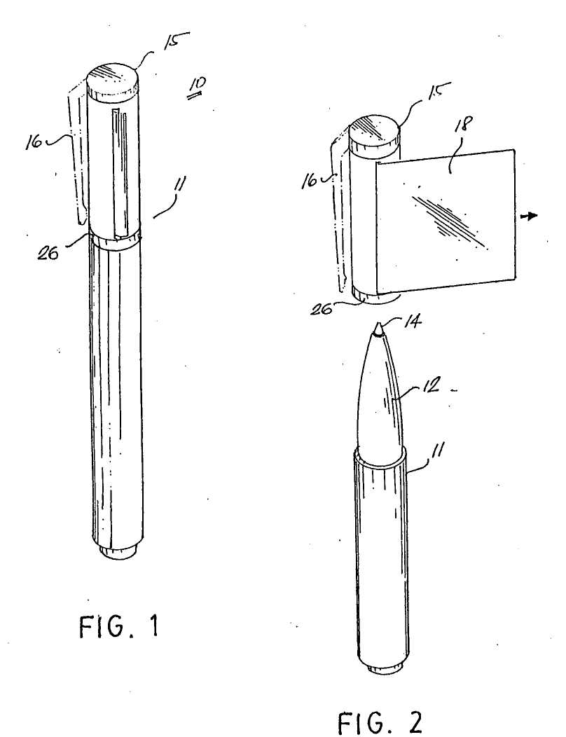

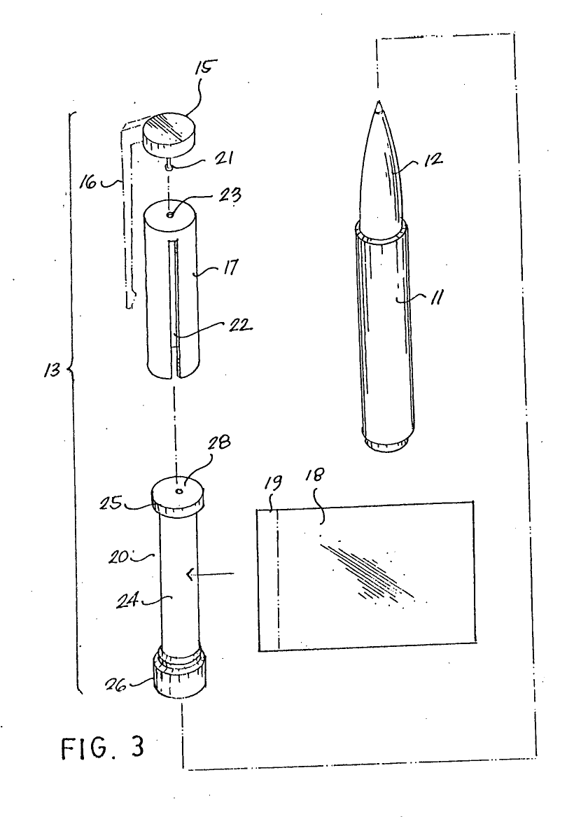

Referring now to the drawings in detail, there is shown in FIG. 1, the present invention for an improved pen generally designated as reference numeral 10, wherein same reference numeral designates same parts throughout.

Said improved pen 10 having a generally cylindrical body 11 with reduced upper body 12 wherein a pen head 14 protrudes thereof is provided with a cap assembly 13.

Said cap assembly 13 comprising of a top lock 15 with clip 16 optionally connected thereof, an outer shell 17, a piece of paper 18 being provided with an adhesive end portion 19 and inner core 20 slideably mounted to the outer shell 17.

The top lock 15 is provided with pin 21 disposed at its bottom portion to provide a steady hold between the outer shell 17 and the inner core 20 when assembled.

The outer shell 17 is provided with an upstanding slit 22 provided on its side and an aperture 23 on its top portion to accommodate the pin 21 of the top lock 15 when engaged and assembled preventing thereof disengagement between the outer shell 17 and inner core 20 when in used.

The inner core 20 having a reduced cylindrical body 24 wherein the piece of paper 18 can be adhesively attached is provided with flanging ends 25 and 26, an aperture 28 on its top portion to accommodate the pin 21 of the top lock 15.

Said inner core 20 is rotatable within the outer shell 17 to allow the piece of paper 18 to roll around its cylindrical body 24 wherein said piece of paper can be retracted through the upstanding slit 22 of the outer shell 17.

It is to be noted that the cylindrical body 11 and the exposed flanging end 26 can be independently twisted in either direction to retract or draw out the paper 18 within the outer shell 17.

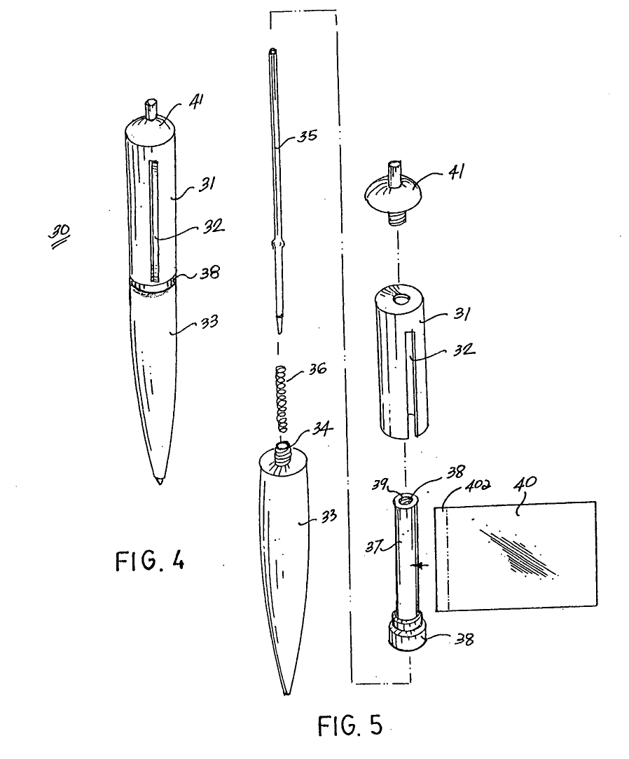

As shown in FIGS. 4 and 5, another embodiment of the present utility model for an improved pen is shown this time for a push button pen type generally designated as reference numeral 30 wherein same reference numeral designates same parts throughout.

As shown in FIG. 5, there is an improved pen of the second embodiment wherein the improvement comprising of a push button type pen 30 having an upper cylindrical body member 31 with an upstanding slit 32, a cylindrically reduced lower body member 33 being provided with a grooved hollow lug 34 on its upper portion, a filler 35 provided with an insertably mounted spring 36 on its front portion is insertably mounted within the cylindrically reduced lower body member 33, a rotatable inner shell 37 provided with a flanged bottom end 38 that is engageably mounted to the lug 34 of the cylindrically reduced lower body member 33 is provided with a top aperture 38 being provided with inner grooves 39, a piece of paper 40 provided with adhesive 40a on its one end portion is adhesively attached to the body of said inner shell 37 wherein the other end thereof is protruding from the upstanding slit 32 of the upper body member 31 and a button cap 41 screwably mounted to the top aperture 38 of the rotatable inner shell 37.

Said cylindrically reduced lower body member 33 can be twisted on either direction to retract or draw out the piece of paper 40.

Said piece of paper 40 is rotatably mounted to the inner shell 37 and can be retracted or pulled out through the upstanding slit 32 of the upper cylindrical body member 31 wherein said paper 40 is replaceable thereof.

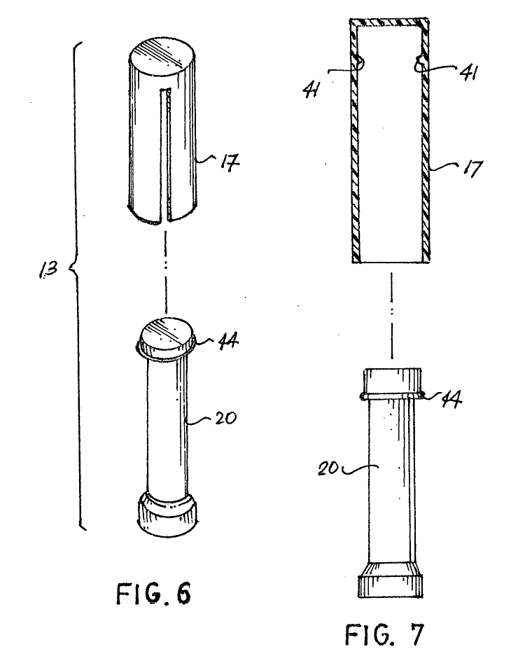

As shown in FIGS. 6 and 7, there is shown another embodiment of the present invention for an improved pen 10 particularly the cap assembly 13 doing away with the top lock 15 and instead provided with an inner groove 41 within the outer shell 17 and a slideably mounted inner core 20 being provided with a protruding groove 44 on its upper portion.

Said outer shell 17 when engage and force fitted with the inner core 20 provides an engaging relationship that allows the inner core 20 to move freely in either direction within the outer shell 17.

Said engagement arrangement allows the present invention to be adaptable to other types of materials in particular plastic or any other pliable materials.

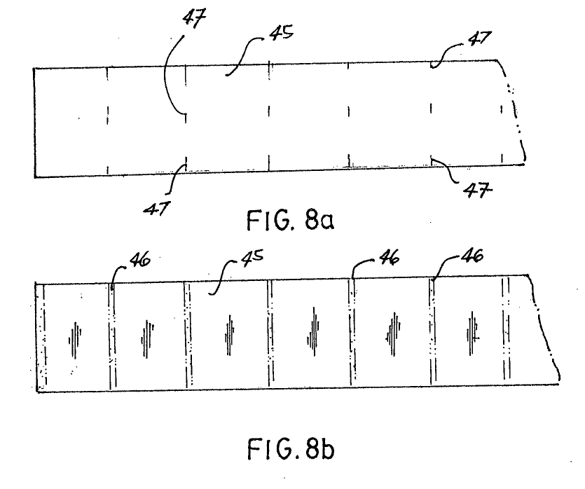

As shown in FIG. 8a, there is shown another embodiment of the present invention showing the piece of paper 45 to be used being provided with adhesives 46 on its back portion and front marking 47 to indicate the location of the adhesives 46 at its back portion thereof.

In FIG. 8b, another embodiment of the present invention shows the piece of paper 45 with spacedly disposed adhesives 46 at its back portion thereof.

### OPERATION

The improved pen 10 of the first embodiment is easy to operate and maintain since it was conceived to provide a pen and a writing pad in one handy and compact configuration.

All the user have to do is to removed the cap to readily make the improved pen ready to use and retract or pull out the piece of paper 18 protruding through the upstanding slit 22 of the outer shell 17 to desired length and the user can start scribbling all the notes the user wanted to write in any situation, in any place at any given time.

When the user has finished scribbling, all he/she had to do is twist either the cylindrical body 11 or the exposed flanging end 26 to retract or completely draw out the piece of paper 18 within the outer shell 17 of the improved pen 10.

In the second embodiment of the present invention, the user will have to completely pull out the piece of paper protruding from the upstanding slit 32 of the upper cylindrical body member 31 to inscribed on it.

When the user is finished scribbling, he can retract the piece of paper back inside the upper cylindrical body member 31 by twisting the cylindrically reduced lower body member 33.

In all embodiments of the present invention the user can either retract or draw out or tear out the desired length of the piece of paper wherein said piece of paper is provided with an adhesive at its back portion capable of attaching said piece of paper to any desired surface thereof.

It is to be noted that in all embodiment said piece of paper is replaceable by just sticking the adhesive end portion of the paper to the reduced cylindrical body 24 or rotatable inner core 37. And rotating in neither direction the flanging end 26 or the cylindrical body 11 or the cylindrically reduced lower body member 33 of the different embodiments.

I claim:

1. An improved pen comprising of a generally cylindrical body with a reduced upper body;
a cap assembly comprising of a top lock and a pin disposed on its bottom portion; an outer shell provided with an upstanding slit provided on its side, an inner core rotatably mounted within the outer shell having a reduced cylindrical body being provided with flanging ends and an aperture on its top portion to accommodate the pin of the top lock;
a piece of paper being provided with an adhesive on its end portion to be attached to the cylindrical body of the inner core wherein said paper protrudes from the upstanding slit of the outer shell and can be retracted or totally pull out from said upstanding slit of the outer shell.

2. An improved pen as claimed in claim 1 wherein said piece of paper is replaceable and is provided with adhesive on one end thereof.

3. An improved pen of the second embodiment comprising of;
a push button type pen having an upper cylindrical body member with an upstanding slit;
a cylindrically reduced lower body member being provided with a grooved hollow lug on its upper portion;
a filler provided with an insertably mounted spring on its front portion is insertably mounted within the cylindrically reduced lower body member;
a rotatable inner core provided with a flanged bottom end that is engageably mounted to the lug of the cylindrically reduced lower body member is provided with a top aperture having provided with inner grooves;
a piece of paper adhesively attached to the body of said inner core wherein the other end thereof is protruding from the upstanding slit of the upper body member and a button cap screwably mounted to the top aperture of the rotatable inner core.

4. An improved pen of the second embodiment as claimed in claim 3 wherein the replaceable piece of paper is adhesively attached to the rotatable inner core.

5. An improved pen of the third embodiment comprising;
An inner core being provided with protruding groove on its upper portion;
an outer shell being provided with inner grove on its upper portion;
said inner core when engaged with the outer shell provides an engaged attachment that allows the inner core to move freely in either direction within the outer shell;

6. An improved pen as claimed in claim 2 wherein the piece of paper is provided with spacedly disposed adhesive at its back portion thereof.

7. An improved pen as claimed in claim 6 wherein the piece of paper is provided with front markings indicating the location of the adhesives disposed on the back of said piece of paper.
